(19) United States
(12) Patent Application Publication
(10) Pub. No.: US 2018/0039964 A1
(43) Pub. Date: Feb. 8, 2018

(54) TRANSACTION SYSTEM

(71) Applicant: MASTERCARD INTERNATIONAL INCORPORATED, Purchase, NY (US)

(72) Inventors: Piyush Sharma, Pune (IN); Elson Rodrigues, Mumbai (IN)

(21) Appl. No.: 15/661,353

(22) Filed: Jul. 27, 2017

(30) Foreign Application Priority Data
Aug. 2, 2016 (SG) 10201606355P

(51) Int. Cl. G06Q 20/20

(52) U.S. Cl. CPC G06Q 20/202; G06Q 20/206

(57) ABSTRACT

There is provided a method of initiating a transaction using a transaction system having at least one transaction terminal, and also a transaction system for initiating a transaction via a transaction terminal. The transaction can be initiated without requiring an account card.

### BACKGROUND OF THE INVENTION

The present invention relates to a transaction system and method, and in one example, to a transaction system and method for initiating a transaction performed using a transaction terminal.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

It is known to perform transactions using terminals, such as a point of sales terminals, automatic teller machines (ATMs) or the like. Such transactions are typically initiated through interaction between the terminal and a physical device, such as an account card, which is scanned or read to allow encoded information indicative of a user account to be retrieved from the card, so that the transaction can be performed using the retrieved information. Similar processes are also now used to allow transactions to be initiated utilising mobile phones, with account information being retrieved from the phone using short range wireless communication between the phone and the transaction terminal.

Such approaches represents a point of weakness in transaction processes, as it is possible for third parties to scan devices to obtain the account information, allowing the details to be used in performing subsequent fraudulent transactions. This process is known as skimming and typically occurs in a number of ways. For example, a transaction terminal can be modified through the use of an additional secondary reader, so that when the user presents their device for reading, the secondary reader reads the account details and routes these to a third party. Such attacks are well known on terminals located in public environments, such as ATMs, and typically operate by scanning the card as it is inserted into the machine.

In another example, this can occur if the user presents their card to a third party for scanning, allowing the third party to fraudulently scan the card through an additional separate card reader. This problem has been exacerbated by the development of contactless technologies, such as near-field communication (NFC), which leads to further vulnerability in the form of high powered reading devices that are capable of reading the devices remotely without physical contact, in which case users may not even be aware that such reading has been performed.

The necessity to present a physical device, such as a card or phone, to a transaction terminal therefore represents a point of weakness in the transaction process. Nevertheless, interaction with a physical terminal remains a popular payment method, and avoids the issues of security vulnerabilities associated with other payment approaches, such as through the use of purely online payment processes.

### SUMMARY OF THE PRESENT INVENTION

There is provided a method of initiating a transaction using a transaction system having a plurality of transaction terminals, at least one payment processing device and a client device, the method including: (a) using the client device to generate a transaction request at least partially in accordance with user input commands, the transaction request being at least partially indicative of a transaction terminal identifier and a user account; (b) transferring the transaction request to the at least one payment processing device via a communications network; (c) using the at least one payment processing device to generate a system message at least partially indicative of the user account; (d) transferring the system message to a respective one of the transaction terminals in accordance with the transaction terminal identifier; and, (e) using the transaction terminal to initiate a transaction in respect of the user account in accordance with the system message, the transaction being performed at least in part in accordance with user interaction with the terminal.

The method can further include: (a) displaying at least one prompt to the user on a terminal display of the terminal; (b) determining transaction details in accordance with user input commands provided following the at least one prompt; (c) causing the transaction to be selectively performed at least partially in accordance with the transaction details; and (d) providing an indication of the transaction details to the at least one payment processing device to allow the transaction to be selectively performed.

It is preferable that the transaction details include at least one of: (a) a user account selection; (b) a transaction amount; and (c) authentication information.

Preferably, the method includes: (a) determining input transaction details supplied via the transaction terminal; (b) determining at least one request transaction detail supplied via the client device; (c) comparing the at least one request transaction detail to the input transaction details; and, (d) causing the transaction to be selectively performed at least partially in accordance with results of the comparison.

It is preferable that at least one payment processing device includes: (a) at least one acquirer processing device; (b) at least one payment network processing device; and, (c) at least one issuer processing device, and wherein the method includes, using the at least one payment network processing device to at least one of: (i) route transaction requests from the client device to the at least one acquirer processing device; (ii) route transaction approval requests and transaction approval responses between the at least one acquirer processing device and the at least one issuer processing device; and, (iii) provide the client device with a list of one or more transaction terminal identifiers in response to a terminal request from the client device.

The method can include, using the at least one payment network processing device to: (a) receive the transaction request; (b) determine an acquirer in accordance with the transaction terminal identifier; and, (c) cause the acquirer to provide the system message to the respective terminal.

It is preferable that the method includes using the at least one acquirer processing device to: (a) generate the system message; and, (b) transfer the system message to the respective terminal.

The method can include: (a) using the client device to generate a terminal request at least partially indicative of a client device location; (b) transferring the terminal request to the at least one payment processing device; (c) using the at least one payment processing device to determine a list of one or more local transaction terminals, the local transaction terminals being within a defined vicinity of the client device location; (d) providing a terminal response to the client device, the terminal response being indicative of transaction terminal identifiers of the local transaction terminals; (e) using the client device to: (i) display an indication of the local transaction terminals; (ii) determine user selection of one of the local terminals in accordance with user input commands; and, (iii) generate the transaction request at least partially in accordance with the transaction terminal identifier of the selected local terminal.

The method can also include executing a software application on the client device to cause the client device to generate the transaction request. The software application can be a mobile wallet application.

Preferably, the transaction terminal is at least one of: (a) an ATM; and, (b) a POS terminal.

It is preferable that the method allows a terminal transaction to be initiated without requiring a physical account identifier.

In another aspect, there is provided a transaction system including: (a) a plurality of transaction terminals, each transaction terminal having: (i) a terminal display; (ii) a terminal input; and, (iii) a terminal processing device; (b) at least one payment processing device; (c) a client device including: (i) a client device display; (ii) a client device input; and, (iii) a client device processing device, preferably in use: (1) the client device: (a) generates a transaction request at least partially in accordance with user input commands, the transaction request being at least partially indicative of a transaction terminal identifier and a user account; and, (b) transfers the transaction request to the at least one payment processing device; (2) the at least one payment processing device: (a) receives the transaction request; (b) generates a system message at least partially indicative of the user account; and, (c) transfers the system message to a respective one of the transaction terminals in accordance with the transaction terminal identifier; and, (3) the transaction terminal: (a) receives the system message; and, (b) initiates a transaction in respect of the user account in accordance with the system message, the transaction being performed at least in part in accordance with user interaction with the terminal.

It is preferable that the system: (a) displays at least one prompt to the user on the terminal display; (b) determines transaction details in accordance with user input commands provided following the at least one prompt; and, (c) causes the transaction to be selectively performed at least partially in accordance with the transaction details.

Preferably, the system provides an indication of the transaction details to the at least one payment processing device to allow the transaction to be selectively performed.

The transaction details include at least one of: (a) a user account selection; (b) a transaction amount; and (c) authentication information.

It is preferable that the system: (a) determines input transaction details supplied via the transaction terminal; (b) determines at least one request transaction detail supplied via the client device; (c) compares the at least one request transaction detail to the input transaction details; and, (d) causes the transaction to be selectively performed at least partially in accordance with results of the comparison.

Preferably, the at least one payment processing device includes: (a) at least one acquirer processing device; (b) at least one issuer processing device; and, (c) at least one payment network processing device that at least one of: (i) routes transaction requests from the client device to the at least one acquirer processing device; (ii) routes transaction approval requests and transaction approval responses between the at least one acquirer processing device and the at least one issuer processing device; and, (iii) provides the client device with a list of one or more transaction terminal identifiers in response to a terminal request from the client device.

The system preferably uses the at least one payment network processing device to: (a) receive the transaction request; (b) determine an acquirer in accordance with the transaction terminal identifier; and, (c) cause the acquirer to provide the system message to the respective terminal.

Preferably, the at least one acquirer processing device: (a) generates the system message; and, (b) transfers the system message to the respective terminal.

It is preferable that the system: (a) uses the client device to generate a terminal request at least partially indicative of a client device location; (b) transfers the terminal request to the at least one payment processing device; (c) uses the at least one payment processing device to determine a list of one or more local transaction terminals, the local transaction terminals being within a defined vicinity of the client device location; (d) provides a terminal response to the client device, the terminal response being indicative of transaction terminal identifiers of the local transaction terminals; (e) uses the client device to: (i) display an indication of the local transaction terminals; (ii) determine user selection of one of the local terminals in accordance with user input commands; and, (iii) generate the transaction request at least partially in accordance with the transaction terminal identifier of the selected local terminal.

Preferably, a software application is executed on the client processing device to cause the client processing device to generate the transaction request. The software application can be a mobile wallet application.

The transaction terminal is preferably at least one of: (a) an ATM; and, (b) a POS terminal.

It is preferable that the system allows a terminal transaction to be initiated without requiring an account card.

In another aspect, there is provided a transaction system for initiating a transaction, the system including a transaction terminal including a terminal processing device that: (a) receives a system message from at least one payment processing device, the system message being least partially indicative of a user account and being generated in response to a transaction request from a user client device; and (b) initiates a transaction in respect of the user account in accordance with the system message, the transaction being performed at least in part in accordance with user interaction with the terminal.

It is preferable that the transaction terminal: (a) displays at least one prompt to the user on a terminal display; (b) determines transaction details in accordance with user input commands provided following the at least one prompt; and, (c) causes the transaction to be selectively performed at least partially in accordance with the transaction details. Preferably, the transaction terminal provides an indication of the transaction details to the at least one payment processing device to allow the transaction to be selectively performed.

It is preferable that the transaction details include at least one of: (a) a user account selection; (b) a transaction amount; and (c) authentication information.

Preferably, the transaction terminal: (a) determines input transaction details in accordance with user input commands; (b) determines at least one request transaction detail from the system message, the at least one request transaction detail associated with the transaction request; (c) compares the at least one request transaction detail to the input transaction details; and, (d) causes the transaction to be selectively performed at least partially in accordance with results of the comparison.

It is preferable that the transaction terminal: (a) generates a transaction approval request at least partially indicative of the transaction details; (b) transfers the transaction approval request to the at least one payment processing device, the at least one the payment processing device being responsive to the transaction approval request to: (i) selectively approve the transaction in accordance with the transaction details; and, (ii) transfer an approval response to the terminal, the approval response being at least partially indicative of an approval outcome; and, (c) in response to the transfer approval response, at least one of: (i) displays an approval outcome; and, (ii) selectively performs a transaction in accordance with the approval outcome.

The transaction terminal is preferably at least one of: (a) an ATM; and, (b) a POS terminal. Preferably, the system allows a terminal transaction to be initiated without requiring an account card.

There is also provided a method of initiating a transaction, the method including in a transaction terminal: (a) receiving a system message from at least one payment processing device, the system message being least partially indicative of a user account and being generated in response to a transaction request from a user client device; and, (b) initiating a transaction in respect of the user account in accordance with the system message, the transaction being performed at least in part in accordance with user interaction with the terminal.

There is provided a transaction system for initiating a transaction via a transaction terminal, the system including at least one payment processing device that: (a) receives a transaction request from a user client device, the transaction request being generated at least partially in accordance with user input commands and being at least partially indicative of a transaction terminal identifier and a user account; (b) generates a system message at least partially indicative of the user account; and, (c) transfers the system message to a respective transaction terminal in accordance with the transaction terminal identifier, the transaction terminal being responsive to the system message to initiate a transaction in respect of the user account at least in part in accordance with user interaction with the terminal.

Preferably, the at least one payment processing device includes: (a) at least one acquirer processing device; (b) at least one payment network processing device; and, (c) at least one issuer processing device.

It is preferable that the at least one payment network processing device, at least one of: (a) routes transaction requests from the client device to the at least one acquirer processing device; (b) routes transaction approval requests and transaction approval responses between the at least one acquirer processing device and the at least one issuer processing device; and, (c) provides the client device with a list of one or more transaction terminal identifiers in response to a terminal request from the client device.

Preferably, the at least one payment network processing device: (a) receives the transaction request; (b) determines an acquirer in accordance with the transaction terminal identifier; and, (c) causes the acquirer to provide the system message to the respective terminal.

The at least one payment network processing device preferably transfers the transaction request to the at least one acquirer processing device, the at least one acquirer processing device being responsive to the transaction request to: (a) generate the system message; and, (b) transfer the system message to the respective terminal.

It is preferable that the at least one payment processing device: (a) receives a transaction approval request at least partially indicative of the transaction details; (b) selectively approves the transaction in accordance with the transaction details; and, (c) transfers an approval response to the terminal, the approval response being at least partially indicative of an approval outcome and the terminal being responsive to the approval response to at least one of: (i) display an approval outcome; and, (ii) selectively perform a transaction in accordance with the approval outcome.

The transaction request can be at least partially indicative of at least one request transaction detail and the at least one payment processing device: (a) receives a transaction approval request from the transaction terminal, the transaction approval request being at least partially indicative of input transaction details determined in accordance with user input commands; (b) compares the at least one request transaction detail to the input transaction details; and, (c) causes the transaction to be selectively performed at least partially in accordance with results of the comparison.

Preferably, the at least one payment processing device: (a) receives a terminal request from the client device, the terminal request being at least partially indicative of a client device location; (b) determines a list of one or more local transaction terminals, the local transaction terminals being within a defined vicinity of the client device location; and (c) provides a terminal response to the client device, the terminal response being indicative of transaction terminal identifiers of the local transaction terminals, the client device being responsive to the terminal response to: (i) display an indication of the local transaction terminals; (ii) determine user selection of one of the local terminals in accordance with user input commands; and, (iii) generate the transaction request at least partially in accordance with the selected local terminal.

In another aspect, there is also provided a method of initiating a transaction via a transaction terminal, the method including in a payment processing device: (a) receiving a transaction request from a client device via a communications network, the transaction request being at least partially indicative of a transaction terminal identifier and a user account; (b) generating a system message at least partially indicative of the user account; and, (c) transferring the system message to the transaction terminal in accordance with the transaction terminal identifier, wherein the transaction terminal is responsive to the system message to initiate the transaction, the transaction being performed at least in part in accordance with user interaction with the terminal.

There is also provided a transaction system for initiating a transaction via a transaction terminal, the system including a user client device including a client device processing device that: (a) generates a transaction request at least partially in accordance with user input commands, the transaction request being at least partially indicative of a transaction terminal identifier and a user account; and, (b) transfers the transaction request to the at least one payment processing device, the at least one payment processing device being responsive to the transaction request to generate a system message that causes a transaction terminal to initiate a transaction in respect of the user account.

Preferably, the client processing device: (a) generates a terminal request at least partially indicative of a client device location; (b) transfers the terminal request to the at least one payment processing device, the at least one payment processing device being responsive to the terminal request to: (i) determines a list of one or more local transaction terminals, the local transaction terminals being within a defined vicinity of the client device location; and (ii) provides a terminal response to the client device, the terminal response being indicative of transaction terminal identifiers of the local transaction terminals; (c) displays an indication of the local transaction terminals; (d) determines user selection of one of the local terminals in accordance with user input commands; and, (e) generates the transaction request at least partially in accordance with the selected local terminal.

The client processing device preferably: (a) determines at least one request transaction detail; and, (b) generates the transaction request at least partially in accordance with the at least one request transaction detail.

The client device can preferably execute a software application causing the client processing device to generate the transaction request. The software application can be a mobile wallet application.

In a final aspect, there is provided a method for initiating a transaction via a transaction terminal, the method including in a user client device: (a) generating a transaction request at least partially in accordance with user input commands, the transaction request being at least partially indicative of a transaction terminal identifier and a user account; and, (b) transferring the transaction request to the at least one payment processing device, the at least one payment processing device being responsive to the transaction request to generate a system message that causes a transaction terminal to initiate a transaction in respect of the user account.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

An example of the present invention will now be described with reference to the accompanying drawings, in which:

FIG. 1 is a flow chart of an example of a process for initiating a transaction;

FIG. 2 is a schematic diagram of an example of a transaction system;

FIG. 3 is a schematic diagram of an example of a processing system;

FIG. 4 is a schematic diagram of an example of a terminal;

FIG. 5 is a schematic diagram of an example of a client device;

FIG. 6 is a schematic diagram of the interactions involved in a typical terminal based transaction process;

FIG. 7 is a flow chart of an example of the steps involved in performing a terminal based transaction process;

FIG. 8 is a schematic diagram of the interactions involved in performing a modified terminal based transaction process;

FIG. 9 is a flow chart of an example of the steps involved in performing a modified terminal based transaction process; and,

FIGS. 10A to 10D are of a flow chart of a more in depth example of the process performing a modified terminal based transaction process.

### DETAILED DESCRIPTION OF THE PREFERRED EMBODIMENTS

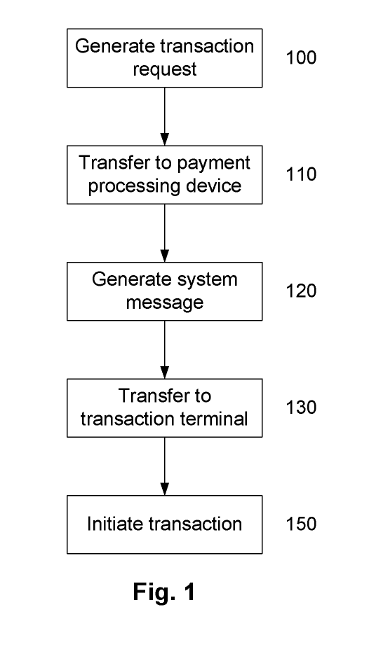

An example of a terminal based transaction process will now be described with reference to FIG. 1.

For the purpose of this example, it is assumed that the process is performed utilising a transaction system including a plurality of transaction terminals, one or more payment processing devices and a client device. The transaction terminals could include any form of transaction terminal and could include a point of sale terminal, ATM, credit card reader or the like. The payment processing device(s) are typically part of one or more processing systems, such as one or more servers, and may form part of a payment network backend, or similar. The client device is typically a suitably programmed mobile communications device, such as a mobile phone, tablet or the like, which can be connected to the payment processing device(s) via a communications network.

In this example, at step 100, the client device is used to generate a transaction request at least partially indicative of a transaction terminal identifier and a user account. The transaction request could be of any appropriate form, and may be generated in any appropriate manner. For example, the transaction request could be in the form of a message generated by an application executed by the client device under user control. Whilst this could be in the form of a generic message, such as an SMS, email, or the like, more typically the message is generated by a custom transaction application, such as a mobile wallet, or similar. However, this is not essential, and other options could include having the message generated by a browser application, for example as part of accessing a website hosted by the payment processing device.

The transaction terminal identifier and details of the user account can be determined in any appropriate manner. For example, this could involve retrieving previously a transaction terminal identifier and/or user account information previously stored on the client device, or in a remote store. Alternatively, this could be entered manually by the user, depending on the preferred implementation.

In one example, the message can include the transaction terminal identifier and details of the user account, although this is not essential, and alternatively the message could include information used to allow these to be retrieved by the payment processing device(s). For example, in the case of the account information, the message could include a unique application identifier, user name, card number, or the like, which is associated with the user account in the backend, allowing information regarding the user account to be retrieved by the processing device once the message has been received. The account information can also be indicative of multiple user accounts, such as a chequing, saving and credit accounts, allowing a respective one of these to be selected to perform the transaction.

At step 110, the transaction request is transferred to the payment processing device(s) via a communications network. This typically involves having the respective application upload a message of the appropriate format, but could be achieved in any suitable way, depending on the nature of the transaction request and available communications options.

At step 120, the payment processing device(s) utilise the transaction request to generate a system message. The system message is typically generated in accordance with a predetermined message protocol or format and is utilised in order to instruct a transaction terminal to take particular actions. In one example, the system message is generated in accordance with a protocol such as ISO8583, which is a common message format for transaction systems, although this is not essential and any suitable system message and message format may be used. The system message is generally at least partially indicative of the user account, and in one particular example includes information that would normally be read from a user's card or other physical device.

At step 130, the system message is transferred to the transaction terminal in accordance with the respective transaction terminal identifier provided in the transaction request. Thus the transaction terminal identifier is used to ensure the system message is transferred to the transaction terminal the user is intending to use to perform the transaction. This is typically performed using normal backend communications channels, as will be appreciated by persons skilled in the art.

At step 140 the transaction terminal initiates the transaction in respect of the user account, in accordance with the system message, and in particular using the account information provided therein. Thus, the system message can instruct the transaction terminal to commence a standard transaction protocol, such as asking the user to provide transaction details allowing the user to proceed with the transaction through appropriate interaction with the terminal.

Accordingly, it will be appreciated that the above described process provides a mechanism for initiating a transaction in a transaction terminal, without requiring the user to present a device, such as an account card, mobile phone or the like, to the transaction terminal directly. Instead, account information is transferred to the transaction terminal via a secure backend, by having the user utilise a trusted client device in order to communicate with a payment processing device and thereby supply the account information. As the user's account details are either securely provided by the client device, or retrieved by the payment processing device, this prevents these being fraudulently obtained by third parties through skimming or other similar mechanisms. As part of this process, the user can also select the respective transaction terminal to be used in performing the transaction, thereby ensuring the correct terminal is used to initiate the transaction.

Accordingly, it would be appreciated that utilising backend communications channels the transaction process can be initiated without requiring the user to present account details to the transaction terminal thereby maintaining security of the transaction details.

Despite this, once the transaction process has been initiated, this allows the user to interact with the terminal in the normal way, such as by having the user provide relevant transaction details including having the user select a relevant account for the transaction, select a transaction amount and undergo authentication. Accordingly, this allows the user to interact with the transaction terminal in a familiar manner thereby ensuring the user is comfortable with the process. This also allows existing security measures to be implemented, thereby maintaining the benefits of interacting with a respective physical transaction terminal, whilst avoiding the issues associated with the skimming of account details.

Furthermore, as this process can be initiated by transferring a system message to the transaction terminal via existing backend infrastructure, this allows the process to be implemented using existing transaction terminals operating in accordance with otherwise standard operating protocols, thereby allowing the process to be implemented using existing payment networks and transaction terminals.

A number of further features will now be described.

In one example, the method includes displaying at least one prompt to the user on a terminal display of the terminal, determining transaction details in accordance with user input commands provided following the at least one prompt and causing the transaction to be selectively performed at least partially in accordance with the transaction details. This can involve allowing the user to perform user account selection, specify a transaction amount, and even input authentication information such as a PIN (personal identification number). Thus, as described above, this allows the user to interact with the transaction terminal in a substantially similar manner to that involved in an existing transaction.

Once the transaction details have been provided to the transaction terminal, these can then be supplied to the at least one payment processing device, thereby allowing the transaction to be selectively performed. In particular, this allows a backend system to perform the transaction in a standard manner utilising processes such as authenticating the user, ensuring the user has sufficient funds to allow the transaction to proceed, and subsequently arranging transfer of funds, or the like, as required.

Additionally, this can be used to provide a further level of security. In particular, in one example the method includes determining input transaction details supplied via the transaction terminal and further determining at least one request transaction detail supplied via the client device as part of the transaction request. By providing at least one transaction detail via both the transaction terminal and the client device, this allows the at least one payment processing device to compare the input and request transaction detail and then cause the transaction to be selectively performed at least partially in accordance with the results of the comparison. For example, this allows the user to enter a transaction amount via the client device, and then subsequently enter the transaction amount again via the transaction terminal. In the event that the entered transaction amounts agree, then the transaction can proceed. Alternatively if the transaction amounts differ, this can highlight that an attempt is being made to utilise the system fraudulently allowing transaction to be halted.

In one example, once transaction details have been provided, the terminal generates a transaction approval request at least partially indicative of the transaction details. This is then transferred to the at least one payment processing device, which is used to selectively approve the transaction in accordance with the transaction details. An approval response is then provided to the terminal, the approval response being at least partially indicative of an approval outcome, with this being used to either display the approval outcome or selectively perform the transaction in accordance with the approval outcome, for example allowing an ATM to dispense currency.

Whilst a single integrated payment processing device can be used, more typically multiple payment processing devices are used, with each operating to provide respective functionality. For example, this can include having at least one acquirer processing device, at least one payment network processing device and at least one issuer processing device.

In this regard, an acquirer is typically an entity such as a financial institution, bank or the like, that processes and settles transactions performed via the transaction terminal. The issuer is a financial institution, bank, credit union or company that administers an account on behalf of the user, whilst the payment network is typically a card network, such as Visa, MasterCard or other similar network that act as an intermediary between the acquirer and the issuer to authorize transactions. It will be appreciated that in some instances, the acquirer and the issuer can be the same entity, although this is not essential.

In any event, in this instance, the at least one payment network processing device is typically utilised in order to route transaction requests from the client device to the at least one acquirer processing device, allowing this to generate system messages. The payment network processing device additionally routes transaction approval requests and responses between the acquirer processing device and the issuer processing device, allowing the issuer to selectively approve transactions on behalf of the user. The network processing device may also provide the client device with a list of one or more transaction terminal identifiers in response to a terminal request from the client device, as will be described in further detail below.

In use, the payment network processing device is typically adapted to receive the transaction request, determine an acquirer in accordance with the transaction terminal identifier determined from the transaction request and then cause the acquirer to provide the system message to the respective terminal. Whilst this can be achieved in any appropriate manner, in one example, acquirers populate a terminal database listing available transaction terminals and their associated transaction terminal identifiers, which can then be accessed by the payment network processing device, as will be described in more detail below.

When determining transaction terminal identifiers, the client device can generate a terminal request at least partially indicative of a client device location, to transfer the terminal request to the at least one payment processing device, which in turn determines a list of one or more local transaction terminals, with local transaction terminals being within a defined vicinity of the client device location. Following this, the at least one payment processing device can provide a terminal response to the client device, with the terminal response being indicative of the transaction terminal identifier. This allows the client device to display an indication of local transaction terminals to the user, allowing the user to select one of these utilising appropriate input commands, so that the client device can then generate the transaction request at least partially in accordance with the selected local terminal.

The client device is typically a mobile phone or other portable device utilised by the user and the method can involve executing the software application on the client device to cause the client device to generate the transaction request. The software application can be a mobile wallet application although this is not essential and other mobile applications could be used. In one example, the transaction terminal is at least one of an ATM and a POS terminal, although this is not essential.

In one broad form the above described process further provides a transaction terminal, and a method of initiating a transaction in a transaction terminal. In this case, the transaction terminal receives a system message from at least one payment processing device, the system message being least partially indicative of a user account and being generated in response to a transaction request from a user client device and initiates a transaction in respect of the user account in accordance with the system message, the transaction being performed at least in part in accordance with user interaction with the terminal.

The transaction terminal can be of any appropriate form, but typically includes a terminal display and terminal input for allowing user interaction, and a processing device for controlling terminal operation.

In one broad form the above described process further provides a transaction system and method for initiating a transaction via a transaction terminal, the system including at least one payment processing device. In this case the payment processing device receives a transaction request from a user client device, the transaction request being generated at least partially in accordance with user input commands and being at least partially indicative of a transaction terminal identifier and a user account, generates a system message at least partially indicative of the user account and transfers the system message to a respective transaction terminal in accordance with the transaction terminal identifier, the transaction terminal being responsive to the system message to initiate a transaction in respect of the user account at least in part in accordance with user interaction with the terminal.

In one broad form the above described process further provides a transaction system and method for initiating a transaction via a transaction terminal, the system including a user client device including a client device processing device that generates a transaction request at least partially in accordance with user input commands, the transaction request being at least partially indicative of a transaction terminal identifier and a user account and transfers the transaction request to the at least one payment processing device, the at least one payment processing device being responsive to the transaction request to generate a system message that causes a transaction terminal to initiate a transaction in respect of the user account.

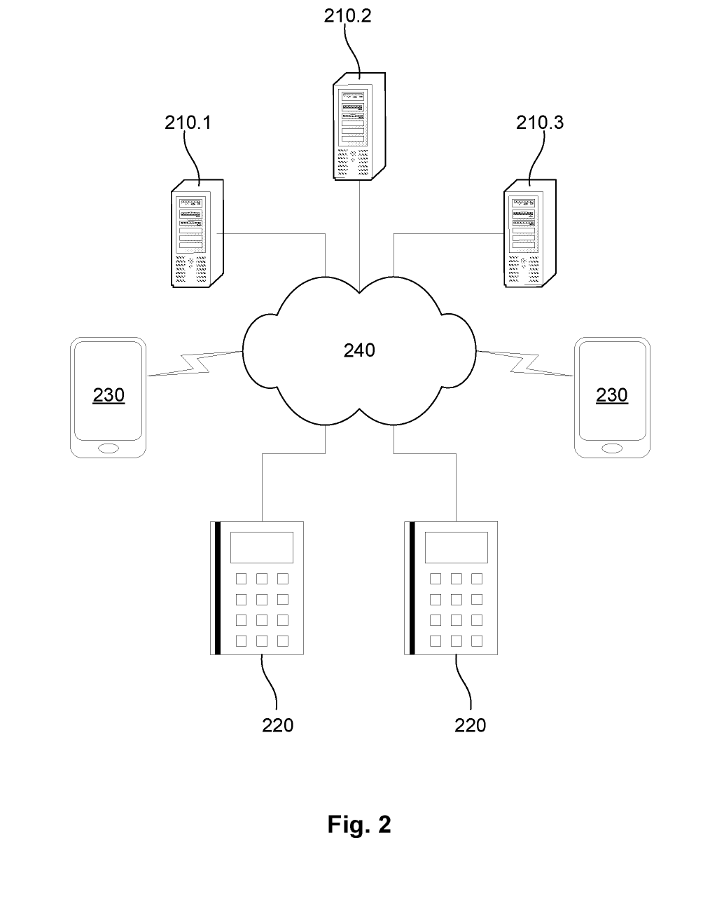

In one example, the process is performed by one or more processing systems operating as part of a distributed architecture, an example of which will now be described with reference to FIG. 2.

In this example, a number of processing systems 210 are provided coupled to one or more transaction terminals 220, and one or more client devices 230, via one or more communications networks 240, such as the Internet, and/or a number of local area networks (LANs).

The processing systems 210 are typically operated by parties, such as acquirers, service providers and issuers, and in one example, three types of processing devices, corresponding to acquirer processing systems 210.1, payment network processing systems 210.2 and issuer processing systems 210.3 are shown. However, it will be appreciated that any number of processing systems and similarly any number of transaction terminals 220 could be provided, and the current representation is for the purpose of illustration only. The configuration of the networks 240 is also for the purpose of example only, and in practice the processing systems 210, transaction terminals 220 and client device 230 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In use, the processing systems 210, are adapted to be perform various data processing tasks forming part of a transaction process, and the particular functionality will vary depending on the particular requirements. For example, the processing systems can be adapted to determine transaction details, determine transaction fees, perform authentication, perform payments, or cause further payment systems (not shown), such as servers of financial institutions, payment gateways or the like, to perform payments, as will be appreciated by persons skilled in the art.

Whilst the processing systems 210 are shown as single entities, it will be appreciated they could include a number of processing systems distributed over a number of geographically separate locations, for example as part of a cloud based environment. Thus, the above described arrangements are not essential and other suitable configurations could be used.

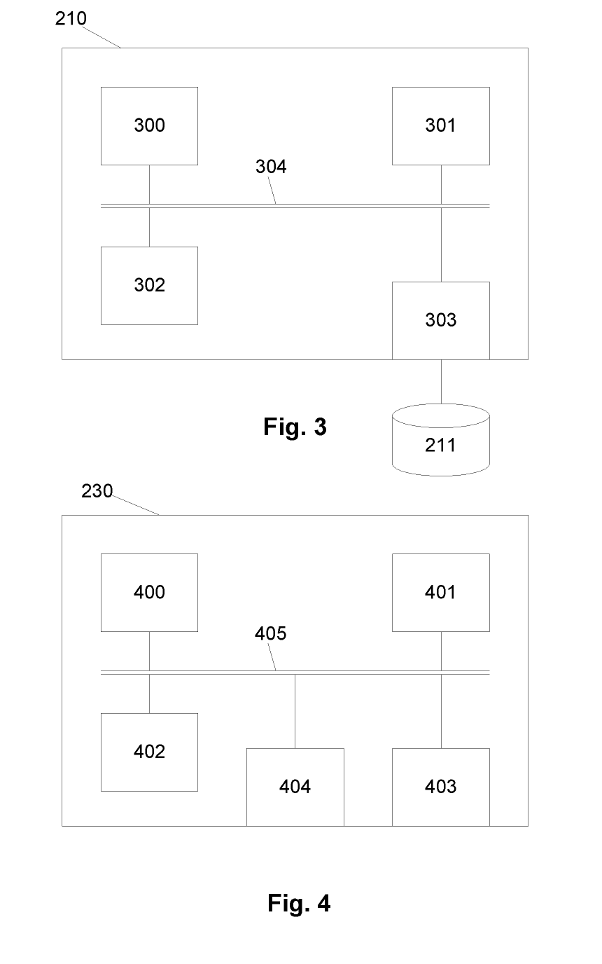

An example of a suitable processing system 210 is shown in FIG. 3. In this example, the processing system 210 includes at least one microprocessor 300, a memory 301, an optional input/output device 302, such as a keyboard and/or display, and an external interface 303, interconnected via a bus 304 as shown. In this example the external interface 303 can be utilised for connecting the processing system 210 to peripheral devices, such as the communications networks 230, databases 211, other storage devices, or the like. Although a single external interface 303 is shown, this is for the purpose of example only, and in practice multiple interfaces using various methods (eg. Ethernet, serial, USB, wireless or the like) may be provided.

In use, the microprocessor 300 executes instructions in the form of applications software stored in the memory 301 to allow the required processes to be performed. The applications software may include one or more software modules, and may be executed in a suitable execution environment, such as an operating system environment, or the like.

Accordingly, it will be appreciated that the processing system 210 may be formed from any suitable processing system, such as a suitably programmed transaction terminal, PC, web server, network server, or the like. In one particular example, the processing system 210 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

As shown in FIG. 4, in one example, the transaction terminal 220 includes at least one microprocessor 400, a memory 401, an input/output device 402, such as a keyboard and/or display, an external interface 403, and typically a card reader 404, interconnected via a bus 405 as shown. In this example the external interface 403 can be utilised for connecting the transaction terminal 220 to peripheral devices, such as the communications networks 230 databases, other storage devices, or the like. Although a single external interface 403 is shown, this is for the purpose of example only, and in practice multiple interfaces using various methods (eg. Ethernet, serial, USB, wireless or the like) may be provided. The card reader 404 can be of any suitable form and could include a magnetic card reader, or contactless reader for reading smartcards, or the like.

In use, the microprocessor 400 executes instructions in the form of applications software stored in the memory 401, and to allow communication with one of the processing systems 210.

Accordingly, it will be appreciated that the transaction terminals 220 may be formed from any suitable transaction terminal, and could include suitably programmed PCs, Internet terminal, lap-top, or hand-held PC, POS terminals, ATMs or the like, as well as a tablet, or smart phone, with integrated or connected card reading capabilities. However, it will also be understood that the transaction terminals 220 can be any electronic processing device such as a microprocessor, microchip processor, logic gate configuration, firmware optionally associated with implementing logic such as an FPGA (Field Programmable Gate Array), or any other electronic device, system or arrangement.

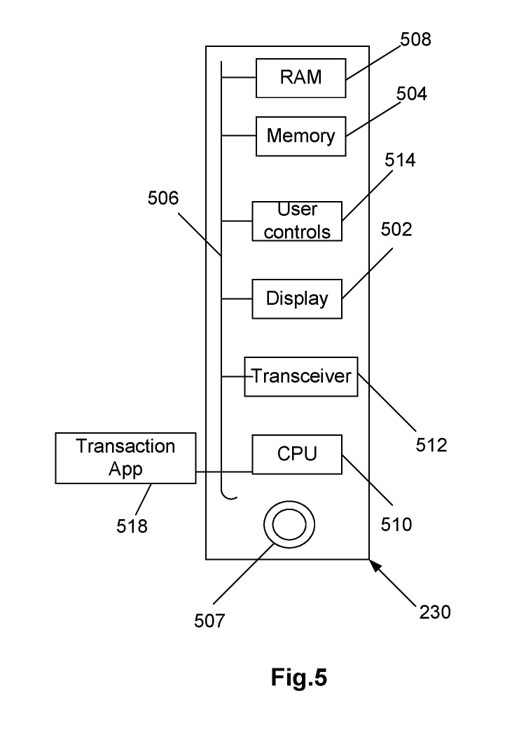

In one example, the client device 230 is a handheld computer device such as a smart phones or a PDA such as one manufactured by Apple™, LG™, HTC™, Research In Motion™, or Motorola™. In one particular example, the client device 230 includes a mobile phone or a computer such as a tablet computer. An exemplary embodiment of the client device 230 is shown in FIG. 5. As shown, the client device 230 includes the following components in electronic communication via a bus 506:

1. a display 502;

2. non-volatile memory 504;

3. random access memory (“RAM”) 508;

4. N processing components 510;

5. a transceiver component 512 that includes N transceivers;

6. user controls 514;

7. microphone/speaker 507.

Although the components depicted in FIG. 5 represent physical components, FIG. 5 is not intended to be a hardware diagram; thus many of the components depicted in FIG. 5 may be realized by common constructs or distributed among additional physical components. Moreover, it is certainly contemplated that other existing and yet-to-be developed physical components and architectures may be utilized to implement the functional components described with reference to FIG. 5.

The display 502 generally operates to provide a presentation of content to a user, and may be realized by any of a variety of displays (e.g., CRT, LCD, HDMI, micro-projector and OLED displays). And in general, the non-volatile memory 504 functions to store (e.g., persistently store) data and executable code including code that is associated with the functional components of a browser component and a transaction App 508. In some embodiments, for example, the non-volatile memory 504 includes bootloader code, modem software, operating system code, file system code, and code to facilitate the implementation of one or more portions of the transaction App 518 as well as other components well known to those of ordinary skill in the art that are not depicted for simplicity.

In many implementations, the non-volatile memory 504 is realized by flash memory (e.g., NAND or ONENAND memory), but it is certainly contemplated that other memory types may be utilized as well. Although it may be possible to execute the code from the non-volatile memory 504, the executable code in the non-volatile memory 504 is typically loaded into RAM 508 and executed by one or more of the N processing components 510.

The N processing components 510 in connection with RAM 508 generally operate to execute the instructions stored in non-volatile memory 504 to effectuate the functional components. As one of ordinarily skill in the art will appreciate, the N processing components 510 may include a video processor, modem processor, DSP, graphics processing unit (GPU), and other processing components.

The transceiver component 512 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

Accordingly, it will be appreciated that the client device 230 be formed from any suitably programmed processing system and could include suitably programmed PCs, Internet terminal, lap-top, or hand-held PC, a tablet, a smart phone, or the like. However, it will also be understood that the client device 230 can be any electronic processing device such as a microprocessor, microchip processor, logic gate configuration, firmware optionally associated with implementing logic such as an FPGA (Field Programmable Gate Array), or any other electronic device, system or arrangement.

Examples of the processes for initiating transactions will now be described in further detail. For the purpose of these examples it is assumed that one or more respective processing systems 210 are servers that provide functionality required of the acquirer, the issuer and the card services provider, and will be referred to respectively as acquirer, issuer and provider servers. The servers 210 typically execute processing device software, allowing relevant actions to be performed, with actions performed by the server 210 being performed by the processor 300 in accordance with instructions stored as applications software in the memory 301 and/or input commands received from a user via the I/O device 302. It will also be assumed that actions performed by the transaction terminal 220, are performed by the processor 400 in accordance with instructions stored as applications software in the memory 401 and/or input commands received from a user via the I/O device 402, whilst actions performed by the client device 230 are performed by the processor 510 in accordance with instructions stored as applications software in the memory 504 and/or input commands received from a user via the user controls 514.

However, it will be appreciated that the above described configuration assumed for the purpose of the following examples is not essential, and numerous other configurations may be used. It will also be appreciated that the partitioning of functionality between the different processing systems may vary, depending on the particular implementation.

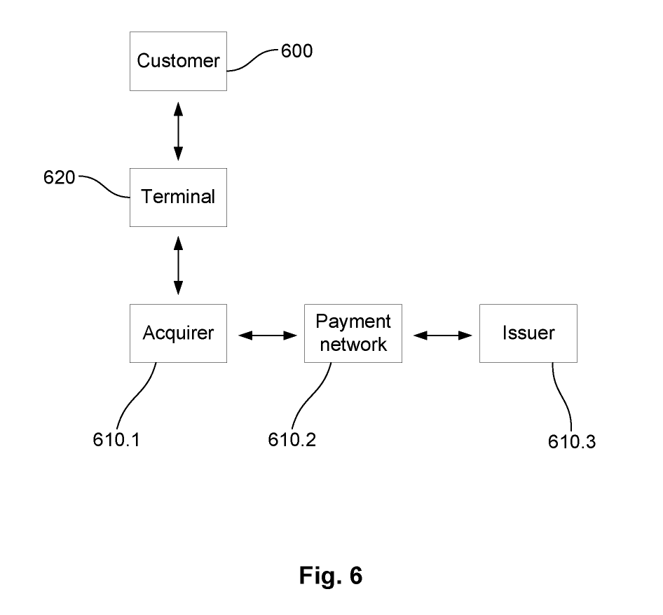

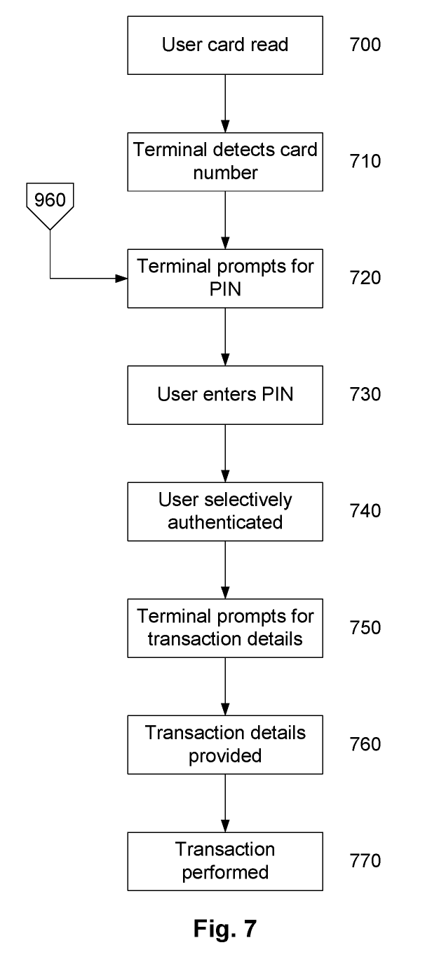

An example of a traditional payment process will now be described with reference to FIGS. 6 and 7.

In this example, a user 600 utilises a terminal 620, such as an ATM or POS terminal, provided by an acquirer, which operates an acquirer server 610.1. The customer's card is provided by a card issuer, operating an issuer server 610.3, with the issuer and acquirer servers being in communication via a payment network server 610.2.

In this example, at step 700 a device, such as a card or phone of the user is read by the terminal 620. For example by inserting the card into a magnetic card reader or holding the card against a tap and go NFC reader. At step 710 the terminal 620 detects the card number and prompts the user to enter a PIN at step 720. The user enters the PIN at step 730, at which point the user is selectively authenticated at step 740.

In this regard, the authentication process typically involves transmitting a system message indicative of the PIN and card number to the acquirer server 610.1, which then transfers this via the payment network server 610.2 to the issuer server 610.3, where the PIN is validated, thereby authenticating the user. An authentication response is then transferred back via the payment network server 610.2 to the acquirer server 610.1, which passes this onto the transaction terminal 620.

At step 750, assuming authentication is successful, the transaction terminal can prompt the user for transaction details, such as allowing the user to select a particular account and nominate a payment amount. It will be appreciated that this step can be performed in advance of providing the card and/or authentication information, depending on the nature of the transaction, and the particular example provided is for the purpose of illustration only.

At step 760 the transaction details are provided, allowing these to be used in performing the transaction. For example, the transaction could be performed by providing transaction details to the acquirer server 610.1, which in turn transfers a transaction approval request via the payment network server 610.2, to the issuer server 610.3. This allows the issuer server 610.3 to selectively approve the transaction, for example depending on whether the user has sufficient funds, and optionally perform part of the transaction by debiting a user account. Approval can be provided to the transaction terminal 620, allowing the transaction terminal 620 to confirm the transaction and optionally take actions such as dispensing currency.

It will be appreciated that a wide range of variations is permissible, depending on the preferred implementation, the nature of the transactions or the like.

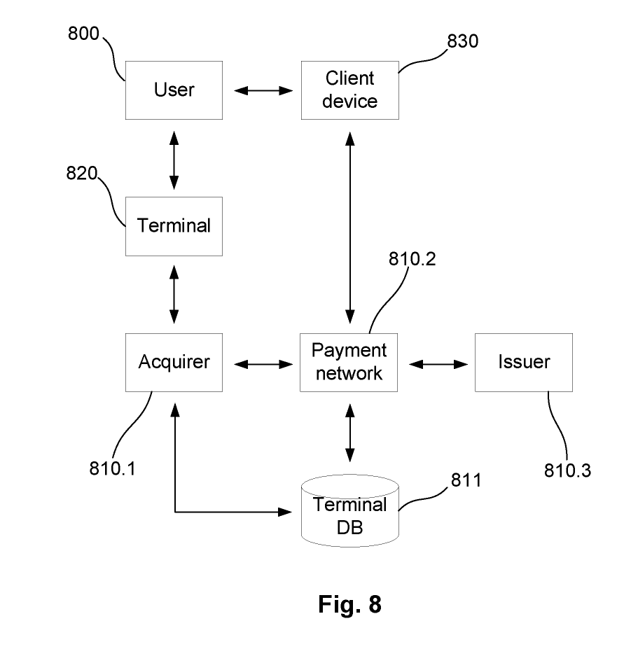

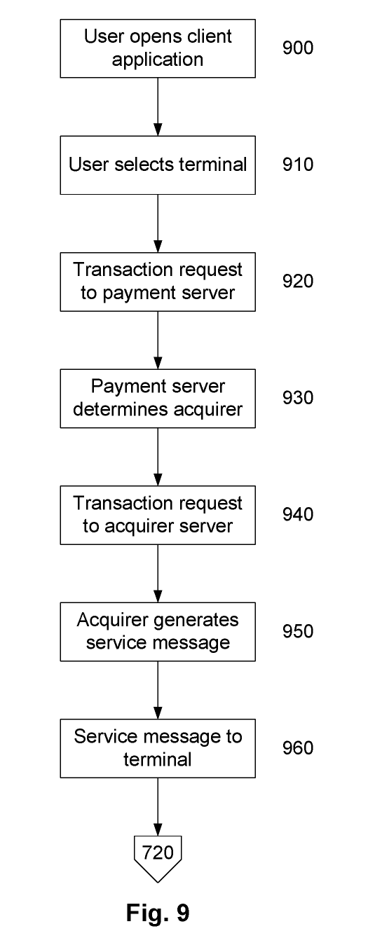

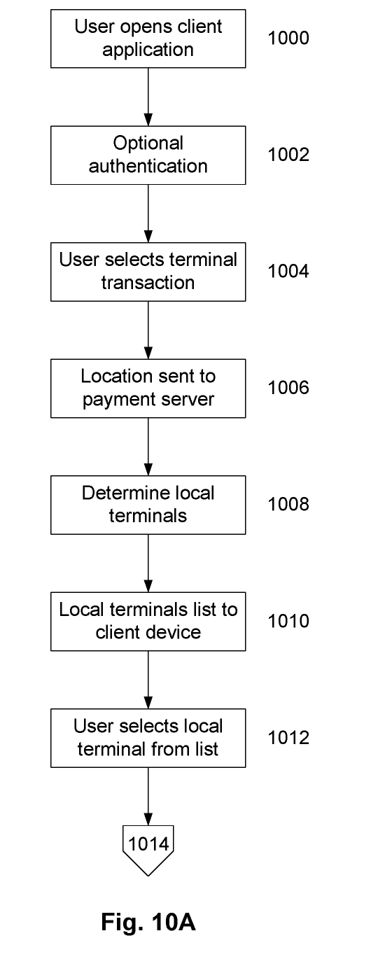

A modified transaction process according to the techniques described herein will now be described with reference to FIGS. 8 and 9.

In this example, as shown in FIG. 8, the customer 800 utilises a client device 830 to interact directly with the payment network server 810.2. The customer also interacts directly with the terminal 820 which in turn interacts with the acquirer server 810.1. The issuer server 810.3 is also in communication with the payment network server 810.2, whilst payment network server 810.2 and acquirer server 810.1 have access to a terminal database 811, which stores transaction terminal identifiers of the transaction terminals 820 associated with each of the respective acquirers providing terminals as part of the system.

An example of a transaction process will now be described with reference to FIG. 9.

In this example, the user opens a client application executed by the client device 830 at step 900 and selects a transaction terminal at step 910. As will be described in more detail below this process can involve retrieving details transaction identifiers from the payment network, or alternatively these can be pre-loaded or entered manually by the user.

At step 920 a transaction request is transferred to the payment server 810.2, with the transaction request including the transaction terminal identifier and user account details, which are typically retrieved from within the client application. Alternatively, an application identifier can be transferred to the payment server 810.2 allowing this to retrieve locally stored account details, as will be appreciated by persons skilled in the art.

At step 930 the payment server 810.2 utilises the transaction terminal identifier to identify the respective acquirer providing the terminal, and then transfers the transaction request to the associated acquirer server 810.1 at step 940. The acquirer server 810.1 generates a service message at step 950, which is transferred to the transaction terminal 820 at step 960, causing this to commence a transaction process. In one particular example, this can involve prompting the user for a PIN and performing the remaining steps in the transaction process 720 to 770 as described above. It will be appreciated however that alternative transaction processes can be performed.

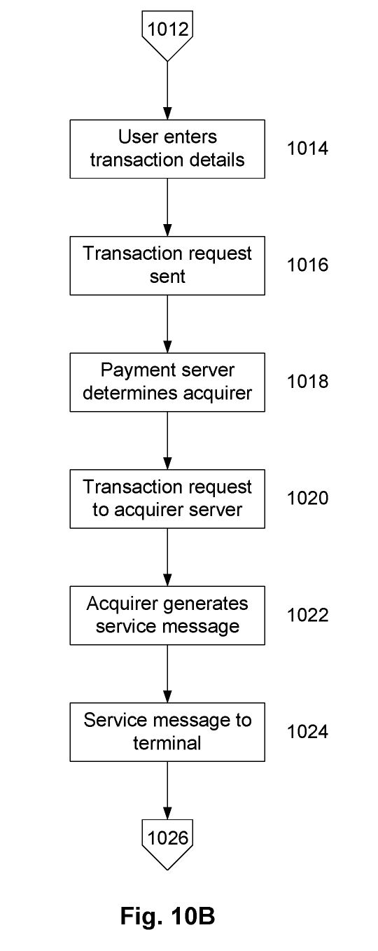

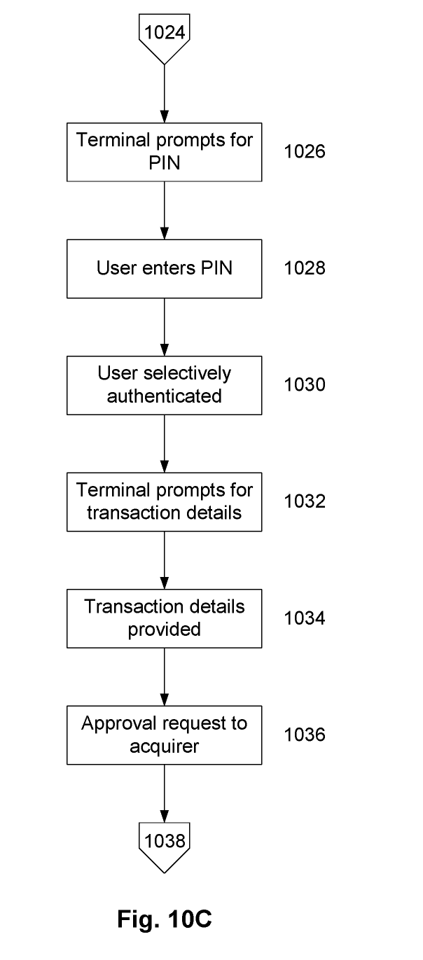

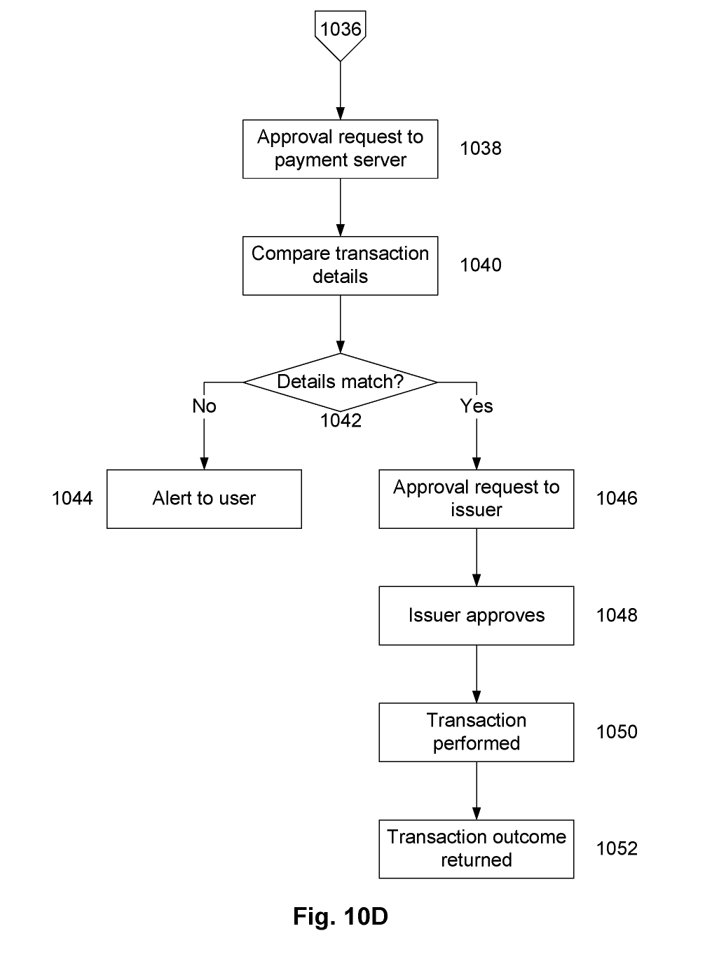

A more in depth example of the transaction process will now be described with reference to FIGS. 10A to 10D.

In this example at step 1000 the user opens the client application and undergoes an optional authentication process at step 1002. This can involve having the user provide a PIN or biometric information allowing the user to be identified as the legitimate user of the client device 830. Such processes are known in the art and will not be described in further detail.

At step 1004, the user selects to perform a transaction using the transaction terminal through an appropriate option displayed via a user interface. At step 1006 the client application determines a current location, for example using location services of the client device 830, and transfers this information to the payment server 810.2. At step 1008, the payment server 810.2 determines terminals local to the current location of the client device 830, and retrieves transaction terminal identifiers from the terminal database 811, providing a list of these to the client device at step 1010. The client device displays a list of local terminals allowing the user to select the correct terminal at step 1012. For example, the list of terminals could indicate the location of local ATMs or transaction terminals in particular shops. This step is performed to allow the user to easily select the transaction terminal they intend to use, whilst avoiding the need for transaction terminals for multiple different terminals to be stored on the device. This information could alternatively be achieved by other means, such as scanning an identifier, such as a QR code or similar, physically provided on the terminal.

In any event, the user enters transaction details at step 1014 via an associated prompt displayed by the client device. This can include selecting a particular transaction account, entering a transaction amount or the like.

At step 1016 the client device application generates a transaction request including the transaction details, account details and transaction terminal identifier with this being sent to the payment server 810.2 at step 1016. The payment server 810.2 determines the acquirer by accessing the transaction terminal database at step 1018, and then transfers the transaction request to the acquirer server 810.1 at step 1020. The acquirer server 810.1 utilises the transaction request to generate a service message and in particular a 0600 ISO8583 service message, which is transferred to the relevant transaction terminal at step 1024, based on the transaction terminal identifier.

At step 1026 the transaction terminal prompts the user for a PIN allowing the user to enter this at step 1028, so that the user can be selectively authenticated at step 1030. It will be appreciated that this is performed in accordance with standard authentication processes similar to those described above.

Assuming the user is successfully authenticated at step 1032, the terminal 820 prompts the user for transaction details, which are then entered by the user at step 1034, and supplied to the acquirer server 810.1 at step 1036. The acquirer server 810.1 provides an approval request which is transferred to the payment server 810.2 at step 1038. The payment server 810.2 compares the transaction details in the approval request to the transaction details provided in the transaction request, from the client device 830, and determines if the details match at step 1042. If the details do not match, this indicates an issue with the transaction and an alert can be provided to the user, either via the transaction terminal 820 and/or via the client device 830. This can be used to allow the user to user to correct details or confirm that the transaction is to be cancelled.

Otherwise, at step 1046, the approval request is transferred to the issuer server 810.3, allowing the issuer to selectively approve the transaction at step 1048. Assuming the transaction is approved this can be performed at step 1050 with the transaction outcome being returned at step 1052, for example allowing this to be displayed to the user either via the transaction terminal 820 in the normal way and/or via the client device 830.

Thus, the above described arrangement allows transactions performed using a terminal to be initiated without requiring reading of a physical device such as an account card or mobile phone. Instead, transactions are initiated by transferring a request from a client device to the payment network, which then causes a system message to be transferred to the terminal, causing the transaction process to commence. This avoids the need to present an account or other similar card, thereby reducing the opportunity for skimming or other fraudulent activities to be performed.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

What is claimed is:

1. A method of initiating a transaction using a transaction system having a plurality of transaction terminals, at least one payment processing device and a client device, the method including:
a) using the client device to generate a transaction request at least partially in accordance with user input commands, the transaction request being at least partially indicative of a transaction terminal identifier and a user account;
b) transferring the transaction request to the at least one payment processing device via a communications network;
c) using the at least one payment processing device to generate a system message at least partially indicative of the user account;
d) transferring the system message to a respective one of the transaction terminals in accordance with the transaction terminal identifier; and,
e) using the transaction terminal to initiate a transaction in respect of the user account in accordance with the system message, the transaction being performed at least in part in accordance with user interaction with the terminal.

2. A method according to claim 1, wherein the method further includes:
a) displaying at least one prompt to the user on a terminal display of the terminal;
b) determining transaction details in accordance with user input commands provided following the at least one prompt; and,
c) causing the transaction to be selectively performed at least partially in accordance with the transaction details.

3. A method according to claim 2, wherein the method includes providing an indication of the transaction details to the at least one payment processing device to allow the transaction to be selectively performed, and
wherein the transaction details include at least one of:
a) a user account selection;
b) a transaction amount; and
c) authentication information.

4. A method according to claim 1, wherein the method further includes:
a) determining input transaction details supplied via the transaction terminal;
b) determining at least one request transaction detail supplied via the client device;
c) comparing the at least one request transaction detail to the input transaction details; and,
d) causing the transaction to be selectively performed at least partially in accordance with results of the comparison,
wherein at least one payment processing device includes:
e) at least one acquirer processing device;
f) at least one payment network processing device; and,
g) at least one issuer processing device, and wherein the method includes, using the at least one payment network processing device to at least one of:
i) route transaction requests from the client device to the at least one acquirer processing device;
ii) route transaction approval requests and transaction approval responses between the at least one acquirer processing device and the at least one issuer processing device; and,
iii) provide the client device with a list of one or more transaction terminal identifiers in response to a terminal request from the client device.

5. A method according to claim 4, wherein the method includes, using the at least one payment network processing device to:
a) receive the transaction request;
b) determine an acquirer in accordance with the transaction terminal identifier; and,
c) cause the acquirer to provide the system message to the respective terminal, and
wherein the method includes using the at least one acquirer processing device to:
d) generate the system message; and,
e) transfer the system message to the respective terminal.

6. A method according to claim 1, wherein the method further includes:
a) using the client device to generate a terminal request at least partially indicative of a client device location;
b) transferring the terminal request to the at least one payment processing device;
c) using the at least one payment processing device to determine a list of one or more local transaction terminals, the local transaction terminals being within a defined vicinity of the client device location;
d) providing a terminal response to the client device, the terminal response being indicative of transaction terminal identifiers of the local transaction terminals;
e) using the client device to:
i) display an indication of the local transaction terminals;
ii) determine user selection of one of the local terminals in accordance with user input commands; and,
iii) generate the transaction request at least partially in accordance with the transaction terminal identifier of the selected local terminal.

7. A method according to claim 1, wherein the method includes executing a software application on the client device to cause the client device to generate the transaction request, the software application being a mobile wallet application,
the transaction terminal being at least one of:
a) an ATM; and,
b) a POS terminal, and
wherein the method allows a terminal transaction to be initiated without requiring a physical account identifier.

8. A transaction system including:
a) a plurality of transaction terminals, each transaction terminal having:
i) a terminal display;
ii) a terminal input; and,
iii) a terminal processing device;
b) at least one payment processing device;
c) a client device including:
i) a client device display;
ii) a client device input; and,
iii) a client device processing device, wherein in use:
(1) the client device:
(a) generates a transaction request at least partially in accordance with user input commands, the transaction request being at least partially indicative of a transaction terminal identifier and a user account; and,
(b) transfers the transaction request to the at least one payment processing device;
(2) the at least one payment processing device:
(a) receives the transaction request;
(b) generates a system message at least partially indicative of the user account; and,
(c) transfers the system message to a respective one of the transaction terminals in accordance with the transaction terminal identifier; and,
(3) the transaction terminal:
(a) receives the system message; and,
(b) initiates a transaction in respect of the user account in accordance with the system message, the transaction being performed at least in part in accordance with user interaction with the terminal.

9. A transaction system according to claim 8, wherein the system:
a) displays at least one prompt to the user on the terminal display;
b) determines transaction details in accordance with user input commands provided following the at least one prompt; and,
c) causes the transaction to be selectively performed at least partially in accordance with the transaction details,
wherein the system provides an indication of the transaction details to the at least one payment processing device to allow the transaction to be selectively performed, and
wherein the transaction details include at least one of:
d) a user account selection;
e) a transaction amount; and
f) authentication information.

10. A transaction system according to claim 8, wherein the system:
a) determines input transaction details supplied via the transaction terminal;
b) determines at least one request transaction detail supplied via the client device;
c) compares the at least one request transaction detail to the input transaction details; and,
d) causes the transaction to be selectively performed at least partially in accordance with results of the comparison,
wherein the at least one payment processing device includes:
e) at least one acquirer processing device;
f) at least one issuer processing device; and,
g) at least one payment network processing device that at least one of:
i) routes transaction requests from the client device to the at least one acquirer processing device;
ii) routes transaction approval requests and transaction approval responses between the at least one acquirer processing device and the at least one issuer processing device; and,
iii) provides the client device with a list of one or more transaction terminal identifiers in response to a terminal request from the client device,
wherein the system uses the at least one payment network processing device to:
h) receive the transaction request;
i) determine an acquirer in accordance with the transaction terminal identifier; and,
j) cause the acquirer to provide the system message to the respective terminal, and
wherein the at least one acquirer processing device:
k) generates the system message; and,
l) transfers the system message to the respective terminal.

11. A transaction system according to claim 8, wherein the system:
a) uses the client device to generate a terminal request at least partially indicative of a client device location;
b) transfers the terminal request to the at least one payment processing device;
c) uses the at least one payment processing device to determine a list of one or more local transaction terminals, the local transaction terminals being within a defined vicinity of the client device location;
d) provides a terminal response to the client device, the terminal response being indicative of transaction terminal identifiers of the local transaction terminals;
e) uses the client device to:
i) display an indication of the local transaction terminals;
ii) determine user selection of one of the local terminals in accordance with user input commands; and,
iii) generate the transaction request at least partially in accordance with the transaction terminal identifier of the selected local terminal,
wherein a software application is executed on the client processing device to cause the client processing device to generate the transaction request, the software application being a mobile wallet application, the transaction terminal being at least one of:
f) an ATM; and,
g) a POS terminal, and
wherein the system allows a terminal transaction to be initiated without requiring an account card.

12. A transaction system for initiating a transaction, the system including a transaction terminal including a terminal processing device that:
a) receives a system message from at least one payment processing device, the system message being least partially indicative of a user account and being generated in response to a transaction request from a user client device; and
b) initiates a transaction in respect of the user account in accordance with the system message, the transaction being performed at least in part in accordance with user interaction with the terminal.

13. A transaction system according to claim 12, wherein the transaction terminal:
a) displays at least one prompt to the user on a terminal display;
b) determines transaction details in accordance with user input commands provided following the at least one prompt; and,
c) causes the transaction to be selectively performed at least partially in accordance with the transaction details,
wherein the transaction terminal provides an indication of the transaction details to the at least one payment processing device to allow the transaction to be selectively performed,
wherein the transaction details include at least one of:
d) a user account selection;
e) a transaction amount; and
f) authentication information,
and wherein the transaction terminal:
g) determines input transaction details in accordance with user input commands;
h) determines at least one request transaction detail from the system message, the at least one request transaction detail associated with the transaction request;
i) compares the at least one request transaction detail to the input transaction details; and,
j) causes the transaction to be selectively performed at least partially in accordance with results of the comparison.

14. A transaction system according to claim 12, wherein the transaction terminal:
a) generates a transaction approval request at least partially indicative of the transaction details;
b) transfers the transaction approval request to the at least one payment processing device, the at least one the payment processing device being responsive to the transaction approval request to:
i) selectively approve the transaction in accordance with the transaction details; and,
ii) transfer an approval response to the terminal, the approval response being at least partially indicative of an approval outcome; and,
c) in response to the transfer approval response, at least one of:
i) displays an approval outcome; and,
ii) selectively performs a transaction in accordance with the approval outcome,
the transaction terminal being at least one of:
d) an ATM; and,
e) a POS terminal, and
wherein the system allows a terminal transaction to be initiated without requiring an account card.

15. A transaction system for initiating a transaction via a transaction terminal, the system including at least one payment processing device that:
a) receives a transaction request from a user client device, the transaction request being generated at least partially in accordance with user input commands and being at least partially indicative of a transaction terminal identifier and a user account;
b) generates a system message at least partially indicative of the user account; and,
c) transfers the system message to a respective transaction terminal in accordance with the transaction terminal identifier, the transaction terminal being responsive to the system message to initiate a transaction in respect of the user account at least in part in accordance with user interaction with the terminal.

16. A transaction system according to claim 15, wherein the at least one payment processing device includes:
a) at least one acquirer processing device;
b) at least one payment network processing device; and,
c) at least one issuer processing device,
wherein the at least one payment network processing device, at least one of:
d) routes transaction requests from the client device to the at least one acquirer processing device;
e) routes transaction approval requests and transaction approval responses between the at least one acquirer processing device and the at least one issuer processing device; and,
f) provides the client device with a list of one or more transaction terminal identifiers in response to a terminal request from the client device,
wherein the at least one payment network processing device:
g) receives the transaction request;
h) determines an acquirer in accordance with the transaction terminal identifier; and,
i) causes the acquirer to provide the system message to the respective terminal.

17. A transaction system according to claim 15, wherein the at least one payment network processing device transfers the transaction request to the at least one acquirer processing device, the at least one acquirer processing device being responsive to the transaction request to:
a) generate the system message; and,
b) transfer the system message to the respective terminal, and
wherein the at least one payment processing device:
c) receives a transaction approval request at least partially indicative of the transaction details;
d) selectively approves the transaction in accordance with the transaction details; and,
e) transfers an approval response to the terminal, the approval response being at least partially indicative of an approval outcome and the terminal being responsive to the approval response to at least one of:
i) display an approval outcome; and,
ii) selectively perform a transaction in accordance with the approval outcome,
wherein the transaction request is at least partially indicative of at least one request transaction detail and wherein the at least one payment processing device:
f) receives a transaction approval request from the transaction terminal, the transaction approval request being at least partially indicative of input transaction details determined in accordance with user input commands;
g) compares the at least one request transaction detail to the input transaction details; and,
h) causes the transaction to be selectively performed at least partially in accordance with results of the comparison, and
wherein the at least one payment processing device:
i) receives a terminal request from the client device, the terminal request being at least partially indicative of a client device location;
j) determines a list of one or more local transaction terminals, the local transaction terminals being within a defined vicinity of the client device location; and
k) provides a terminal response to the client device, the terminal response being indicative of transaction terminal identifiers of the local transaction terminals, the client device being responsive to the terminal response to:
i) display an indication of the local transaction terminals;
ii) determine user selection of one of the local terminals in accordance with user input commands; and,
iii) generate the transaction request at least partially in accordance with the selected local terminal.

18. A transaction system for initiating a transaction via a transaction terminal, the system including a user client device including a client device processing device that:
a) generates a transaction request at least partially in accordance with user input commands, the transaction request being at least partially indicative of a transaction terminal identifier and a user account; and,
b) transfers the transaction request to the at least one payment processing device, the at least one payment processing device being responsive to the transaction request to generate a system message that causes a transaction terminal to initiate a transaction in respect of the user account.

19. A transaction system according to claim 18, wherein the client processing device:
a) generates a terminal request at least partially indicative of a client device location;
b) transfers the terminal request to the at least one payment processing device, the at least one payment processing device being responsive to the terminal request to:
i) determines a list of one or more local transaction terminals, the local transaction terminals being within a defined vicinity of the client device location; and
ii) provides a terminal response to the client device, the terminal response being indicative of transaction terminal identifiers of the local transaction terminals;
c) displays an indication of the local transaction terminals;
d) determines user selection of one of the local terminals in accordance with user input commands; and,
e) generates the transaction request at least partially in accordance with the selected local terminal.

20. A transaction system according to claim 18, wherein the client processing device:
a) determines at least one request transaction detail; and,
b) generates the transaction request at least partially in accordance with the at least one request transaction detail,
wherein the client device executes a software application causing the client processing device to generate the transaction request, the software application being a mobile wallet application.
